(19) United States
(12) Patent Application Publication
(10) Pub. No.: US 2005/0186306 A1
(43) Pub. Date: Aug. 25, 2005

(54) Low carbohydrate cereal-like food product

(76) Inventors: Susanne Sonneveld, Laval (CA); Nathalie Lefebvre, St-Janvier (CA)

Correspondence Address: LADAS & PARRY LLP, 224 SOUTH MICHIGAN AVENUE, SUITE 1600, CHICAGO, IL, 60604, US

(21) Appl. No.: 10/782,478

(22) Filed: Feb. 19, 2004

(51) Int. Cl. A23C 9/12

(52) U.S. Cl. 426/72

(57) ABSTRACT

A food product, suitable for a controllled carbohydrate diet comprises identifiable pieces of cereal-like core held together with a binding agent, with the product being 30% or less in digestible carbohydrate. The product may be consumed as part of a weight loss or maintenance program, or as nutritional support in any case where escessive blood sugar is to be avoided, such as in subjects suffering from excess weight or obesity, hyperglycemia, insulin resistance and types I and I diabetes.

### FIELD OF THE INVENTION

The invention relates to a food product and methods of preparation and use thereof. More particularly, the invention relates to a cereal-like food product suitable for use as part of a controlled carbohydrate diet.

### BACKGROUND OF THE INVENTION

The number of overweight or obese individuals has become very significant in many populations, a trend which continues to increase. Numerous studies have demonstrated a correlation of increasing or excessive body weight with a number of diseases and in turn increased morbidity. Notably, excessive body weight has been associated with an increased risk of cardiovascular disease, cancer, diabetes and digestive disease, as well as other conditions, with severity of such disease linked to the extent of excess weight. As such, weight loss and maintenance reduce such health risks. Such weight loss and maintenance is typically effected and managed by various approaches, including diet, exercise, drugs, surgery and combinations thereof.

It has been shown that controlling carbohydrate intake contributes to weight loss and maintenance (Sinha, R. et al., (2002) New Eng. J. Med. 346:802; Atkins, R. C. (2002) Dr. Atkins' New Diet Revolution). However, due to the differences in the amounts and types of carbohydrates in different foods, it is not always convenient for subjects following a controlled carbohydrate regime to prepare a meal consistent with such carbohydrate requirements. Further, problems often arise due to circumstances that preclude the consumption of a conventional meal. As a result, there is a need for ready to eat or convenience-type foods suitable for a controlled carbohydrate diet.

The need for such ready to eat or convenience-type foods is particularly applicable to breakfast. However, for a food to be consumed at breakfast, it is desirable for it to have the flavor and texture associated with familiar cereal-type foods to which many people are accustomed. While a number of ready to eat breakfast-type foods are known (e.g. cereal-type foods), due to limitations in how their nutritive content may be varied while maintaining a palatable product, none provide the nutritive properties required for a controlled carbohydrate diet.

While low carbohydrate, ready to eat foods are known, their taste and texture is very different from cereal-based foods, and the degree of acceptance of such low-carbohydrate foods as a breakfast-type food is not very good.

Accordingly, there is a need to provide a low-carbohydrate food product, such as a ready to eat breakfast-type food product, which offers a more familiar cereal taste and texture and is thus likely to promote a better dietary compliance.

### SUMMARY OF THE INVENTION

The invention relates to a low carbohydrate cereal-like food product.

Accordingly, in a first aspect, the invention provides a low carbohydrate ready to eat food product comprising a cereal-like core that forms at least about 15% by weight of said food product.

In a further aspect, the invention provides a low carbohydrate ready to eat food product comprising digestible carbohydrate less than or equal to 30% by weight of said food product and at least 15% by volume of identifiable pieces of cereal-like core.

In a further aspect, the invention provides a low carbohydrate ready to eat food product comprising a core of agglomerated identifiable cereal-like pieces, wherein said product comprises at least 15% by weight of said agglomerated cereal-like pieces, and wherein said cereal-like pieces have a median size of at least 2 mm.

In a further aspect, the invention provides a layered food product comprising the above-noted food product, wherein said food product is in the form of a matrix core, wherein said layered food product comprises at least two of said matrix cores and an edible layer portion situated therebetween, wherein said layer portion occupies at least part of the interface between said matrix cores, and wherein said layer portion is substantially free of pieces of cereal-like core.

In a further aspect, the invention provides a low carbohydrate ready to eat food product suitable for a controlled carbohydrate diet, wherein said product comprises less than or equal to 30% by weight of digestible carbohydrate and wherein said food product exhibits a texture profile having an average peak density of at least 1 peak per millimetre penetration depth when analyzed using a TA.XT Plus texture analyzer machine following a 45 degree chisel blade test.

In a further aspect, the invention provides a low carbohydrate ready to eat food product suitable for a controlled carbohydrate diet, wherein said product comprises less than or equal to 30% by weight of digestible carbohydrate and wherein said food product exhibits a texture profile having a global maximum at a first depth of penetration and a plurality of isolated local maxima at a respective plurality of second depths of penetration when analyzed using a TA.XT Plus texture analyzer machine following either a 45 degree chisel blade test.

In a further aspect, the invention provides a low carbohydrate ready to eat food product, comprising at most 30% by weight of digestible carbohydrate, said food product having a thickness and exhibiting a texture profile of force versus depth of penetration when analyzed using a TA.XT Plus texture analyzer machine following either a 45 degree chisel blade test, wherein said texture profile is characterized by:
(a) a global maximum force at a first depth of penetration;
(b) a global width equal to the difference between a second depth of penetration and a third 15 depth of penetration, the second depth of penetration being less than the first depth of penetration, the third depth of penetration being greater than the first depth of penetration, the second and third depths of penetration corresponding to respective points on said profile where the force is equal to 50% of said global maximum force, said global width being at least 80% of the thickness of the food product; and
(c) a plurality of local peaks appearing in a density of at least one per millimeter penetration depth, each local peak characterized by a respective fourth depth of penetration at which the force exhibits a local maximum and a respective fifth depth of penetration at which the force exhibits a local minimum, wherein the difference between the respective fourth and fifth depths of penetration is between 1% to 25% of said global width, wherein each local peak is further characterized by a respective local amplitude equal to the difference between the force at the respective fourth depth of penetration and the force at the respective fifth depth of penetration, the respective local amplitude being at least 1% of said global maximum force.

In a further aspect, the invention provides a coated food product comprising the above-mentioned food product, wherein said food product is a solid matirix core, and wherein said coated food product further comprises a coating covering at least a part of said matrix core.

In a further aspect, the invention provides a layered food product comprising the above-mentioned food product, wherein said food product is in the form of a matrix core, wherein said layered food product comprises at least two of said matrix cores and an edible layer portion situated therebetween, wherein said layer portion occupies at least part of the interface between said matrix cores, and wherein said layer portion is substantially free of pieces of cereal-like core.

In a further aspect, the invention provides a method for preparing a food product suitable for a controlled carbohydrate diet, said method comprising:
(a) providing ingredients comprising at least 15% by weight of pieces of cereal-like core, wherein said ingredients collectively comprise less than 30% by weight of digestible carbohydrate;
(b) providing a binding agent which is substantially free of simple sugars;
mixing said binding agent with with said ingredients thereby to obtain a moldable mass; and
(c) forming said moldable mass into said food product.

In a further aspect, the invention provides a food product suitable for a controlled carbohydrate diet produced by the above-mentioned method.

In a further aspect, the invention provides a method of providing nutritional support to a subject comprising orally administering to said subject the above-mentioned food product. In an embodiment the subject is a mammal, in a further embodiment a human.

In a further aspect, the invention provides a commercial package comprising the above-mentioned food product.

### BRIEF DESCRIPTION OF THE DRAWINGS

In the drawings, embodiments of the invention are illustrated by way of example. It is to be expressly understood that the description and drawings are only for purposes of illustration and as an aid to understanding, and are not intended to be a definition of the limits of the invention.

FIG. 1 shows results of texture analysis of an apple bar according to an embodiment of the invention, performed using the 45 degree chisel blade test as described in Example 13. Panels A and B represent duplicate test results.

FIG. 2 shows comparative results of texture analysis of a non-cereal low carbohydrate bar (an Atkins Advantage™ Almond Bronwnie bar), performed using the 45 degree chisel blade test as described in Example 13. Panels A and B represent duplicate test results.

### DETAILED DESCRIPTION OF THE INVENTION

According to a non-limiting example of implementation, the invention provides a ready to eat low carbohydrate food product comprising one or more cereal-like solid cores. The food product can be in the form of a bar, a baked product such as a cookie, or in loose particulate form.

The solid cereal-like core is made of agglomerated particles, that are held together with a binding agent. In a non-limiting example of implementation, the binding agent is substantially free of sugar.

The food product may comprise any number of edible ingredients, including but not limited to proteinaceous material (binding and/or filler protein), fat (e.g. vegetable oil, tropical oils) carbohydrate (digestible and indigestible), vitamins (e.g. vitamins A, B1, B2, B6, B12, C, D and/or E, niacin and/or folic acid), minerals (e.g. sodium, potassium, calcium, magnesium, iron, chlorine, phosphorus, sulphur and/or iodine), trace elements (e.g. zinc, copper, manganese, chromium, selenium and/or molybdenum), flavours (natural and/or artificial), sweeteners, lecithin, etc.

“Total carbohydrate” as used herein refers to the sum total of carbohydrates in a particular composition or product. As set forth in 21 CFR 101.9 (c)(6) of the regulations of the US Food and Drug Administration (FDA), “Total carbohydrate content shall be calculated by subtraction of the sum of the crude protein, total fat, moisture, and ash from the total weight of the food. This calculation method is described in A. L. Merrill and B. K. Watt, “Energy Value of Foods—Basis and Derivation,” USDA Handbook 74 (slightly revised 1973) pp. 2 and 3.”

“Digestible carbohydrate” as used herein refers to a carbohydrate which, when ingested by an animal, has an impact on the blood sugar level of the animal. Digestible carbohydrate may be calculated by subtracting dietary fiber, added fiber [isolated, nondigestible carbohydrates such as polydextrose and fibersol], and glycerin, sugar alcohols (e.g. maltitol, sorbitol), and any other non-glycemic impacting compounds normally classified as carbohydrates from “total carbohydrate” content. The various components noted above may be determined using analytical methods known in the art. References to certain of such methods are indicated in Example 12. Examples of digestible carbohydrate include but are not limited to simple sugars, starch, and any carbohydrate which may be cleaved under physiological conditions (e.g. in the digestive tract) to yield simple sugars.

In contrast, “indigestible carbohydrate” a used herein refers to a carbohydrate which, when ingested by an animal, makes little or no impact on the blood sugar level of the animal relative to a digestible carbohydrate. A composition or product which has “little or no impact” when the composition or product is ingested refers to postprandial levels of blood glucose which are no more than 20% of the corresponding postprandial level following the consumption of an equivalent amount of digestible carbohydrate. Examples of indigestible carbohydrate include but are not limited to dietary fiber, gums, polydextrose, sugar alcohols, fructo-oligosaccharides, inulin and/or fibersol.

Substantially sugar free” or “substantially free of sugar” as used herein when in reference to a preparation or composition means that no simple sugars from a heterologous source have been added to the preparation or composition. It would thus include preparations that intrinsically contain trace amounts of simple sugars, such as small amounts of monomeric units that remain in the preparation of a sugar polymer.

“Simple sugar” as used herein refers to a monosaccharide or disaccharide or combinations thereof (e.g. glucose, fructose, lactose and sucrose). This term does not include sugar alcohols or sugar or carbohydrate polymers that contain three or more monomeric units (i.e. trisaccharrides or greater), nor does it include non-carbohydrate molecules.

“Low carbohydrate” as used herein in reference to a particular composition or product refers to a product that has digestible carbohydrate less than or equal to about 30% by weight of the food product.

A two prong verification is used to define a product of the invention. The first prong relates to the amount of digestible carbohydrate in the product. Using the definitions and references to analytical methods described herein, the amount of digestible carbohydrate may be calculated. This value is less than or equal to 30% by weight of the product.

The second prong relates to the cereal-like nature of the core of the product, i.e. in that it has a cereal-like core. “Cereal-like core” as used herein refers to an agglomeration of readily identifiable particles. Two different tests can be used for establishing if this prong of the verification is met. Two different tests can be used for establishing if this prong of the verification is met. It suffices that only one of the two tests be successful to consider that the second prong is met. The first test relates to the amount and type of particles used in making the core. Specifically, this verification requires that the core includes at least 15% by weight of particles, the particles having a median size of at least 2 mm. Such particles may include pieces or nuggets coming from grains, cereals & legumes, nuts, seeds, fruit, coconut, caramel (e.g. sugar-reduced), chocolate and/or other fat based or indigestible carbohydrate based ingredients. Non-limiting examples of such readily identifiable particles, which are referred to herein as “pieces of cereal-like core”, are listed below. The balance of the core can include particles having a median size smaller than 2mm (e.g. fine powders), liquid/syrup/gel-consistency material. The first test therefore relates to determining the amount of particles having a certain median size. This is determined by breaking apart the particles in the agglomerate (i.e. pulling them apart from each other) and then measuring the size of the particles. The size may be measured either by sieving analysis or by direct measurement (e.g. using a measuring device such as a vernier caliper), e.g. as noted in Example 9 below. The various sizes of the particles can be used to calculate the median size, based on the measured largest dimension of the individual particles. Such analyses are presented in Example 9 below. The total weight of such particles is measured and related to the total weight of the product, thus calculating the % of such particles by weight in the product. In an embodiment, such a particles or pieces of cereal-like core have a median size of least 2 mm, in further embodiments, a median size of at least 3, 4, 5, 6, 7, 8, 9, 10, 11, 12, 13, 14, 15, 16, 17, 18, 19 or 20 mm. In further embodiments, the median size is from about 2 to about 20 mm, from about 3 to about 15 mm, or from about 6 to about 10 mm.

Non-limiting examples of such pieces of cereal-like core include the following: Grains, Cereals and Legumes may in embodiments include: soybeans, peas, lentils, chickpeas, corn, rice, oats, barley, chicory, rye, beans and/or wheat and any products made thereof.

Nuts may in embodiments include: peanuts, almonds, hazelnuts, walnuts, cashews, macadamia or Brazil nuts and/or other nuts and any products made thereof.

Seeds may in embodiments include: sunflower, sesame, poppy, flax, pumpkin and/or other seeds and any products made there of.

Fruit may in embodiments include: berries, apples, orange and/or lemon peel, apricots, plums and/or other fruit and any products made there of. In an embodiment such fruit is of reduced moisture or substantially free of moisture (typically known as dried fruit).

Coconut may in embodiments include: sweetened or unsweetened coconut and any product made thereof.

Sugar reduced caramel may in embodiments include: caramel bits or pieces which are mainly composed of indigestible carbohydrates and fats, with or without added protein. In embodiments, the caramel can have other ingredients added to it to alter its flavour, such as cocoa powder, chocolate, nuts or other ingredients.

Chocolate may include: chocolate chips or chunks which are mainly composed of indigestible carbohydrates, fats and protein.

Other fat based ingredients may include: chips, chunks or nuggets which are mainly composed of indigestible carbohydrate and fat, with or without added protein.

Indigestible carbohydrate based ingredients may include: nuggets or pieces which are mainly composed of indigestible carbohydrate, with or without added fat or protein.

Other protein based ingredients may include: whey or gelatin based nuggets or pieces mainly composed of protein, with or without added fat or carbohydrate.

The second test which may be used to establish that the second prong of the verification is met relates to a measurement of the texture of the product using a TA.XT Plus™ texture analyzer device (Texture Technologies, Scarsdale, N.Y., USA). Details of how such measurements are made are set forth in Example 13 below. The test entails penetrating the product a certain distance with a 45 degree chisel blade probe and measuring the force profile during the penetration. The measurements are presented as a graph of force per distance penetrated into the product. In this case, the verification is met if the texture profile contains a plurality of peaks (rather than a smooth profile). This texture profile may be described as a texture profile having an average peak density of at least 1 peak per millimeter penetration depth. This texture profile may also be described as having a global maxima (i.e. an overall large peak) at a first depth of penetration and a plurality of isolated local maxima at a respective plurality of second depths of penetration (i.e. smaller peaks on the ascending and/or descending portion of the large peak). This texture profile may also be described as be characterized by:
(a) a global maximum force at a first depth of penetration;
(b) a global width equal to the difference between a second depth of penetration and a third depth of penetration, the second depth of penetration being less than the first depth of penetration, the third depth of penetration being greater than the first depth of penetration, the second and third depths of penetration corresponding to respective points on said profile where the force is equal to 50% of said global maximum force, said global width being at least 80% of the thickness of the food product; and
(c) a plurality of local peaks appearing in a density of at least one per millimeter penetration depth, each local peak characterized by a respective fourth depth of penetration at which the force exhibits a local maximum and a respective fifth depth of penetration at which the force exhibits a local minimum, wherein the difference between the respective fourth and fifth depths of penetration is between 1% to 25% of said global width, wherein each local peak is further characterized by a respective local amplitude equal to the difference between the force at the respective fourth depth of penetration and the force at the respective fifth depth of penetration, the respective local amplitude being at least 1% of said global maximum force.

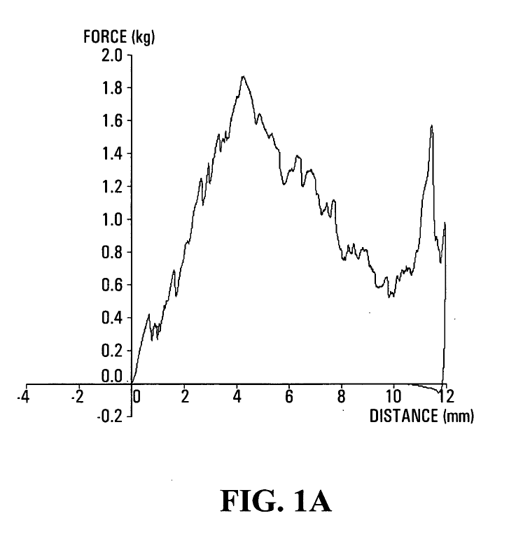

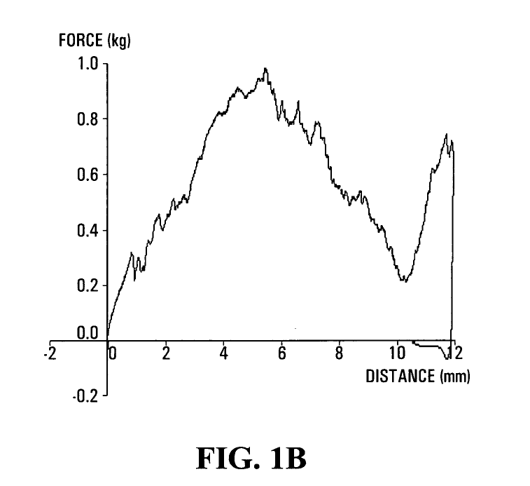

Therefore, in a non-limiting example, the invention provides a food product suitable for a controlled carbohydrate diet, which has certain texture properties as determined using a TA.XT Plus texture analyzer machine, as described in Example 13 below. Specifically, the texture properties are determined using the 45 degree chisel blade test. The results are expressed as a texture profile of force (e.g. in kg) per distance of penetration (e.g. in mm). In one specific and non-limiting example, the texture profile has an average peak density of at least 1 peak per millimeter of penetration. In a further aspect, the texture profile shows a maximum at a first depth of penetration, and one or more isolated maxima at one or more respective second depths of penetration, where the second depth of penetration may be greater or less than the first depth of penetration. In a further aspect, the texture profile is characterized by the global maxima, global width and plurality of local peaks noted above. Representative texture profiles are shown in FIG. 1. At least 10 replicate tests are performed. The verification of the test is met if at least 7 per 10 replicates exhibit the texture profile described herein.

“Water activity” as used herein refers to a measure of the energy status of the water in a system, and a description of this parameter and a method for its measurement are set forth in Example 8 below. This parameter is well known in the food industry. In embodiments, the product of the invention has a water activity greater or equal to about 0.2, in a further embodiment less than or equal to about 0.4, in a further embodiment in the range from about 0.2 to 0.4. In further embodiments the product has a water activity from about 0.2 to about 0.36, from about 0.24 to about 0.4 and from about 0.24 to about 0.33, determined as set forth in Example 8.

Throughout this application, various references are referred to describe more fully the state of the art to which this invention pertains. The disclosures of these references are hereby incorporated by reference into the present spcification.

The product of the invention may be prepared using a binding agent or liquid component comprising binder syrup. The ingredients used in the making of the syrup portion may be in powdered form or in concentrated liquid form and may include: fibers, gums, fructose oligosaccharides (FOS), inulin, sugar alcohols, glycerin, polydextrose, maltodextrin (fibersol), soy protein isolate, whey protein, whole milk protein, hydrolyzed gelatin, egg albumin and wheat gluten. In an embodiment, the binding agent comprises hydrolyzed gelatin.

In one non-limiting example of implementation, the product comprises at least about 15% pieces of cereal-like core (by weight). In other non-limiting examples, the product comprises at least about 20, at least about 25, at least about 30, at least about 35, at least about 40, at least about 45, at least about 50, at least about 55, at least about 60, at least about 65, at least about 70 or at least about 75% pieces of cereal-like core by weight.

In a further non-limiting example, the product comprises at least about 15% by volume pieces of cereal-like core. In a further non-limiting examples, the product comprises at least about 20, at least about 25, at least about 30, at least about 35, at least about 40, at least about 45, at least about 50, at least about 55, at least about 60, at least about 65, at least about 70, or at least about 75% pieces of cereal-like core by volume. The % volume of the product which is occupied by pieces of cereal-like core may for example be measured by measuring the volume of the entire product and of the pieces of cereal-like core therein, and using these two values to calculate the percentage.

In a non-limiting example, the product comprises less than or equal to about 30% by weight of digestible carbohydrate In specific and non-limiting examples of implementation, food products having digestible carbohydrate content of about 25%, of about 20%, of about 15%, of about 10%, of about 5% and of about 3% are in the scope of this invention.

In a non-limiting example, the pieces of the cereal-like core or identifiable particles comprises pieces or nuggets comprising protein. In embodiments, such protein-comprising nuggets comprise at least 60% protein, in a further embodiment, at least 75% protein (by weight).

In embodiments, the pieces of the cereal like core or identifiable particles comprises pieces or nuggets which comprise less than 40% digestible carbohydrate, in a further embodiment, less than 25% digestible carbohydrate, in a further embodiment less than 10% digestible carbohydrate (by weight).

In an embodiment, the pieces of the cereal-like core or identifiable particles comprise at least 25% of such protein-comprising nuggets, in further embodiments, at least 30%, 35%, 40%, 45% or 50% of such protein-comprising nuggets (by weight).

In an embodiment, the product comprises at least 10% of such protein-comprising nuggets, in further embodiments, at least 15%, 20%, 25%, 30%, 35%, or 40% of such protein-comprising nuggets (by weight). In embodiments such protein-comprising nuggets are selected from the group consisting of soy nuggets and soybean pieces.

The food product (e.g. a bar) manufactured under one or more examples of implementation of the invention, may take various forms. In one specific example, the food product is formed by a single cereal-like core that may take different shapes and sizes. One possible shape is a bar shape. The cereal-like core may be partially or substantially completely coated with a suitable coating. The cereal-like core may be bottom-coated, top-coated, or overall coated or enrobed. Suitable coatings include but are not limited to chocolate, carob, peanut-based or “white” coatings such as cream, yogurt and vanilla (or other flavored) coatings. In one specific example of implementation, the coating is selected such as to deliver less than about 30% by weight of digestible carbohydrate. In one non-limiting example of implementation, the selected coating is substantially free of simple sugars. In one non-limiting example of implementation, the selected coating makes up to about 50% or less of the finished coated product by weight.

In another non-limiting example of implementation, the product may comprise two or more cereal-like solid cores separated by intervening material. The intervening material may be in the form of a layer that may be a water-based and/or a fat-based composition, which in an embodiment is substantially free of simple sugar. The layer is substantially free of large particles that are of a shape and size comparable to those making up the cereal-like core. In another non-limiting example of implementation, the layer may be situated on top of a cereal-like solid core, i.e. an upper layer. The optional layer may be caramel, chocolate, peanut, vanilla or another flavor. The layer may make up to 50% or less of the finished layered product by weight.

In yet another possible form of implementation, the product may comprise both a layered structure and a coating.

The invention further relates to methods of preparing the above-mentioned food product. In one example of implementation, the method of preparing the food product in a bar format includes mixing the wet and dry ingredients with heating, and then forming the mixture into a slab of appropriate bar thickness. The slab may then be sliced into strips which are then cut transversely into bars. Alternatively, the mixture may be formed into strips and then cut into bars or formed into bars directly. The actual forming of the mixture into a slab or strips can be done by techniques well known to those skilled in the art.

In an embodiment, the food product of the invention is a ready to eat food product, meaning that the product, once prepared and provided to the subject, does not require any cooking prior to consumption.

The following examples are illustrative of various embodiments of the invention, and do not limit the broad aspects of the invention as disclosed herein.

### EXAMPLES

### Example 1

### Preparation of Apple Bar

Final Bar Weight: 37 grams
Final Bar: 169 calories
Core: 23.6 grams (64%)

Coating: 13.4 grams (36%)

BINDER SYRUP

| Ingredient | % |
|---|---|
| Glycerin | 58.0 |
| Water | 3.0 |
| Maltitol | 7.0 |
| Sucralose | 0.11 |
| Flavour | 0.08 |
| Hydrolyzed gelatin | 19.81 |
| Sunflower Oil | 10.0 |
| Lecithin, liquid | 2.0 |

To make the syrup:
1. Glycerin and water heated to 85° C. (or higher) in steam kettle.
2. Maltitol, sucralose, and flavor dissolved in the glycerin mixture and pumped to a hold tank. Cooled to 60° C.

3. Powdered hydrolyzed gelatin, oil and lecithin added and mixed vigorously until well blended and lump free. Heated to 70° C.

CORE

| | % |
|---|---|
| Powders | |
| Cellulose | 2.5 |
| Hydrolyzed gelatine | 2.95 |
| Malic Acid | 0.1 |
| Vitamin premix | 0.25 |
| Dicalcium phosphate | 2.15 |
| Powdered flavours | 1.7 |
| Spice | 0.23 |
| Pieces | |
| Soya nuggets | 23.9 |
| Chopped soybeans | 14.75 |
| Chopped Almonds | 14.0 |
| Dried Apples ¼″ | 4.0 |
| Other liquids | 31.27 |
| Liquid flavours | 0.7 |
| Sunflower oil | 1.5 |

To make the bar matrix:
1. Pre-weighed powders above as a premix.
2. Pre-weighed pieces above.
3. Syrup (65°-70° C.) and liquid flavors (i.e. listed as “other liquids” above) combined with the dry pre-weighed ingredients of 1 and 2. All ingredients mixed 120 seconds in summix mixer, adding the remaining sunflower oil (i.e. listed as “other liquids” above) during the last 40 seconds of the mix time.
   The Matrix is formed into a slab, cooled, slit and cut at the guillotine, coated, cooled again and packaged.

### Example 2

### Preparation of Chocolate Chip Bar

Final Bar Weight: 37 grams
Final Bar: 160 calories
Coating: 17% (Bottom Coat)
Core: 74%
Chips: 9% (Chips on core)

BINDER SYRUP The syrup was made as per Example 1.

CORE

| | % |
|---|---|
| Powders | |
| Powdered Cellulose | 2.5 |
| Hydrolyzed gelatine | 2.92 |
| Vitamin premix | 0.2 |
| Dicalcium phosphate | 1.68 |
| Powdered flavour | 0.15 |
| Pieces | |
| Soya nuggets | 24.53 |
| Chopped soybeans | 18.27 |
| Unsweetened coconut | 6.0 |
| Other liquids | 31.25 |
| Liquid flavours | 0.5 |
| Sunflower oil | 1.5 |
| Chocolate Chips | 10.5 |

The bar matrix is prepared as per Example 1. The chocolate chips are added after the slab is formed. The matrix is formed into a slab, the chips are sprinkled on the slab and compressed down, cooled, slit and cut at the guillotine, bottom coated, cooled again and packaged.

### Example 3

### Preparation of Layered Bar

Bar Breakdown:
Total: 60.00 g
Matrix: 54 %
Coating: 21 %

Layer: 25 %

BINDER SYRUP

| Ingredients | Percentage % |
|---|---|
| Flavor | 0.08 |
| Glycerin | 63.00 |
| Sucralose | 0.11 |

The following ingredients were then added:

| | |
|---|---|
| Lecithin | 2.0 |
| Sunflower Oil | 15.0 |
| Hydrolyzed Gelatin | 19.81 |

The flavor and sucralose were mixed and dissolved in the glycerin with heating (85° C.) and then cooled to 60° C. The other ingredients are then added with agitation and with heating to 70° C. to facilitate dissolution of the gelatin. It has been observed that vigorous agitation prevents the gelatin from forming lumps and that a syrup temperature of 70° C. (158° F.) or higher facilitates complete dissolution of the gelatin protein.

CORE

| Ingredients | Percentage % |
|---|---|
| Powders | |
| Prepared salt | 0.30 |
| Cellulose | 1.50 |
| Vitamin and mineral premix | 3.20 |
| Powdered polydextrose | 2.20 |
| Hydrolysed gelatin | 3.40 |
| Peanut flour | 8.12 |
| Pieces | |
| Peanut pieces | 6.00 |
| Soy nugget | 34.73 |
| Liquids | |
| Syrup | 28.32 |
| Sunflower oil | 1.53 |
| Liquid flavor | 2.70 |
| Peanut split | 8.00 |
| Total | 100.00 |

The matrix was made as follows:
1. Powders preweighed as a premix.
2. Pieces preweighed.
3. Liquid added (50°-60° C.) with the dry preweighed ingredients of 1 and 2. All ingredients mixed 120 seconds in summix mixer, adding the remaining oil (listed under “liquids” above) during the last 40 seconds of the mix time. (peanut split is added after the slab is formed).
   The matrix was formed into a slab, the peanut split is sprinkled onto the slab, compressed down, layered (with caramel) with a wet applicator, cooled, slit and cut with a guillotine, coated, and cooled again.

### Example 4

### Preparation of Granola-Type Bar A

Bar breakdown:
Total bar: 50 g
Matrix: 81.50 %
Bottom coating: 18.50 %

BINDER SYRUP Syrup was prepared as per Example 3.

CORE

| Ingredients | Percentage % |
|---|---|
| Powders | |
| Cellulose | 2.30 |
| Flavor | 1.73 |
| Vitamin and mineral premix | 2.54 |
| Powdered polydextrose | 2.33 |
| Hydrolysed gelatin | 2.09 |
| Pieces | |
| Fine coconut-dry | 1.85 |
| Soybean pieces | 5.50 |
| Sliced almonds | 7.00 |
| Soy nuggets | 33.00 |
| Rolled Oats | 8.50 |
| Liquids | |
| Syrup | 30.65 |
| Sunflower oil | 1.50 |
| Liquid flavor | 1.01 |
| Total | 100.00 |

The matrix was made as follows:
1. Powders preweighed as a premix.
2. Pieces preweighed.
3. Liquid added (50°-60° C.) with the dry preweighed ingredients of 1 and 2. All ingredients mixed 120 seconds in summix mixer, adding the oil during the last 40 seconds of the mix time.
   The matrix was formed into a slab, cooled, slit and cut with a guillotine, coated, and cooled again.

### Example 5

### Preparation of Granola-Type Bar B

Bar breakdown:
Total bar: 35 g
Matrix: 100%

BINDER SYRUP Syrup was prepared as per Example 3.

CORE

| Ingredients | Percentage % |
|---|---|
| Powders | |
| Cellulose | 2.42 |
| Flavor | 2.00 |
| Vitamin premix | 0.17 |
| Dicalcium phosphate anhydrous | 1.45 |
| Powdered polydextrose | 2.38 |
| Hydrolysed gelatin | 2.63 |
| Pieces | |
| Fine coconut-dry | 1.94 |
| Soybean halves | 4.84 |
| Sliced almonds | 6.30 |
| Soy nuggets | 25.32 |
| Rolled Oats | 4.85 |
| Sliced cranberries FD | 2.90 |
| Peanut pieces | 4.84 |
| Sunflower seeds | 4.84 |
| Liquids | |
| Syrup | 31.62 |
| Sunflower oil | 1.50 |
| Total | 100.00 |

The bar matrix is made as per Example 4, except that the bar is not coated.

### Example 6

### Preparation of Cookie

Ingredients (per 100 g):

| | |
|---|---|
| Premix 1 | |
| Cellulose | 0.85 g |
| Dried Apples | 1.35 g |
| Chopped Almonds | 4.73 g |
| Chopped soybeans | 4.99 g |
| Hydrolyzed gelatin | 1.00 g |
| Soya nuggets | 8.08 g |
| Powdered Polydextrose | 2.00 g |
| Powdered flavours | 1.7 g |
| Spice | 0.23 g |
| Malic acid | 0.10 g |
| Total | 25.03 g |
| Premix 2 | |
| Soya protein | 7.97 g |
| Fiber | 10.00 g |
| Wheat bran | 6.00 g |
| Arabic gum | 1.00 g |
| Sodium bicarbonate | 0.63 g |
| Ammonium bicarbonate | 0.14 g |
| Total | 25.74 g |
| Binder syrup | |
| Lecithin, liquid | 0.49 g |
| Sunflower oil | 3.68 g |
| Hydrolyzed gelatin | 4.86 g |
| Glycerin | 15.45 g |
| Sucralose | 0.03 g |
| Flavours | 0.02 g |
| Total | 24.53 g |
| Other liquid ingredients | |
| Shortening | 14.00 g |
| Water | 10.00 g |
| Flavours | 0.70 g |
| Total | 24.70 g |
| Grand total | 100.0 g |

Method:
1. Premix 1 and premix 2 were mixed together.
2. The syrup was prepared as follows:
   sucralose and flavours were dissolved in glycerin with heating to 80° C
   the solution was cooled to 50 to 60° C.
   oil and lecithin were added with mixing
   hydrolyzed gelatin was added with vigorous mixing until homogeneous consistency
   mixture heated to 70° C.
4. The other liquid ingredients were added to the syrup and mixed.
5. The liquid mixture obtained in step 3 was added to the dry mixture obtained in step 1 and the resulting mixture was mixed until the components were evenly distributed in the mixture.
6. For each cookie, 35 g of the mixture obtained in step 5 was dropped (using a spoon) onto a non-stick pan.
7. The cookies were baked at 350° F. (180° C.) for 15-20 min.

### Example 7

### Preparation of Cereal

Ingredients (per 100 g):

| | |
|---|---|
| Premix 1 | |
| Cellulose | 2.95 g |
| Dried Apples | 4.72 g |
| Chopped Almonds | 16.51 g |
| Chopped soybeans | 17.40 g |
| Hydrolyzed gelatin | 3.48 g |
| Soya nuggets | 28.18 g |
| Powdered Polydextrose | 2.00 g |
| Powdered flavours | 1.7 g |
| Spice | 0.23 g |
| Malic acid | 0.10 g |
| Total | 77.27 g |
| Binder syrup | |
| Lecithin, liquid | 0.44 g |
| Sunflower oil | 3.30 g |
| Hydrolyzed gelatin | 4.36 g |
| Glycerin | 13.89 g |
| Sucralose | 0.02 g |
| Flavours | 0.02 g |
| Total | 22.03 g |
| Other liquid ingredients | |
| Flavours | 0.70 g |
| Total | 0.70 g |
| Grand total | 100.0 g |

Method:
1. The Syrup was prepared as follows:
   sucralose and flavours were dissolved in glycerin with heating to 80° C.
   the solution was cooled to 50 to 60° C.
   oil and lecithin were added with mixing
   hydrolyzed gelatin was added with vigorous mixing until homogeneous consistency
   mixture (i.e. syrup) heated to 70° C.
2. The other liquid ingredients (i.e. flavours) were added to the syrup and mixed.
3. The liquid mixture obtained in step 2 was added to premix 1 and the resulting mixture was mixed until the components were evenly distributed in the mixture.
4. The mixture from step 3 was placed on a non-stick pan and cooked under the broiler until a golden color was obtained (about 5 min.). The resulting cereal appeared as clusters or aggregates of pieces of cereal-like core.

### Example 8

### Water Activity

Table 1 sets forth Water Activity measurements for the products described in Examples 1-7 above. Details of how this value was measured are outlined below.

TABLE 1
Average water activity in products of Examples 1-7.

| Product (Example) | Water activity^{a} |
|---|---|
| apple bar (1) | 0.244 |
| chocolate chip bar (2) | 0.257 |
| layered bar (3) | 0.292 |
| granola-type bar A (4) | 0.256 |
| granola-type bar B (5) | 0.321 |
| cookie (6) | 0.327 |
| cereal (7) | 0.303 |

^{a}Average of two readings.

By way of background and technical theory of water activity, the Operator's Manual Version 1.5 [Chapter 9. Theory: Water Activity in Products (page 49-52)] for the AquaLab™ Series 3TE (Water Activity Meter) notes the following:

“Water is a major component of foods, pharmaceuticals and cosmetics. Water influences the texture, appearance, taste and spoilage of these products. There two basic types of water analysis: water content and water activity . . . . Water content implies a quantitative analysis to determine the total amount of water present in a sample . . . . The limitations of water content measurement are attributed to differences in the intensity with which water associates with other components.

Water activity is a measure of the energy status of the water in a system, and thus is a far better indicator of perishability than water content . . . . Water activity of a system is measured by equilibrating the liquid phase water in the sample with the vapor phase water in the headspace and measuring the relative humidity of the headspace. In the AquaLab, a sample is placed in a sample cup which is sealed against a sensor block. Inside the sensor block is a fan, a dew point sensor, a temperature sensor, and an infrared thermometer. The dew point sensor measures the dew point temperature of the air, and the infrared thermometer measure the sample temperature. From these measurements the relative humidity of the headspace is computed as the ratio of dew point temperature saturation vapor pressure to saturation vopor pressure at the sample temperature. When the water activity of the sample and relative humidity of the air are in equilibrium, the measurement of the headspace humidity gives the water activity of the sample. The purpose of the fan is to speed equilibrium and to control the boundary layer conductance of the dew point sensor.

In addition to equilibrium between the liquid phase water in the sample and the vapor phase, the internal equilibrium of the sample is important. If a system is not at internal equilibrium, one might measure a steady vapor pressure (over the period of measurement) which is not the true water activity of the system. An example of this might be a baked good or a multi-component food. Initially out of the oven, a baked good is not at internal equilibrium; the outer surface is at a lower water acitivity than the center of the baked good. One must wait a period of time in order for the water to migrate and the system to come to internal equilibrium. It is important to remember the restriction of the definition of water activity to equilibrium.”

A representative method to measure water activity in respect of a product of the invention (which was used to obtain the data of Table 1) comprises the following steps. An AquaLab™ (Series 3TE) device is used:
1. Turn on the AquaLab™ device.
2. Let the machine heat up for 15 minutes before using.
3. Set the AquaLab sample chamber temperture to 21° C.
4. Fill sample cup half full with uncoated product (e.g. bar). Make sure the sample to be measured is homogeneous and at room temperture.
5. Put the sample cup into the AquaLab device sample drawer and slide closed.
6. Turn the sample drawer knob to READ position to seal the sample cup with the chamber.
7. Wait until the reading is complete (the AquaLab device will beep once and the LED indicator light will flash).
8. Read and document the results of the Aw as well as the temperture recorded.
9. Turn sample drawer knob to OPEN/LOAD position and prepare the next sample.
10. Two readings are taken of each sample.

### Example 9

### Size of Pieces of Cereal-Like Core Used

The size of pieces of cereal-like core used were determined by sieving the pieces through screens of defined aperture size, using a Ro-Tap Sieve Shaker machine device (sieving for 1 minute). Tables 2-4 describe the parameters used and the results obtained.

TABLE 2
Analysis of size of pieces of cereal-like core by sieving

| | % of particles retained | | | | | | | | |
|---|---|---|---|---|---|---|---|---|---|
| Piece of cereal- | Sieve # | | | | | | | | |
| like core | ¼ | 4 | 5 | 6 | 8 | 10 | 12 | 14 | pan |
| Solnuts pieces | | | 7.1 | | 79.3 | | | | 13.2 |
| Sunflower | | 58.0 | 39.0 | | | | | | 1.8 |
| seeds | | | | | | | | | |
| Peanut split | 95.0 | 4.3 | | | | | | | 0.3 |
| Soybean halves | | 82.0 | 14.8 | | | | | | 4.5 |
| Chocolate | | 95.9 | | | | | | | 5.0 |
| chips | | | | | | | | | |
| Large oat | | 18.3 | 38.2 | 22.1 | 10.0 | | | | 6.3 |
| flakes | | | | | | | | | |
| # 5 | | | | | | | | | |
| Sliced | 45.0 | 11.8 | 6.0 | 5.1 | 9.0 | 3.0 | 3.4 | 3.2 | 14.0 |
| cranberries | | | | | | | | | |
| Sliced almonds | 65.0 | 16.8 | 8.5 | 5.2 | 2.0 | | | | 0.5 |
| Crumbled | 2 | 30 | | 16 | 14 | | | | 30 |
| almonds¹ | | | | | | | | | |
| Roasted | | 35 | | 60- | | | | | 15 |
| chopped | | | | 80 | | | | | |
| peanuts¹ | | | | | | | | | |
| FXP H0309^{1,2} | | | | | | | | | |

¹Values obtained from manufacturer's technical specifications
²A protein product available from The Solae Company

TABLE 3
Technical specifications of sieves used

| Sieve # | Aperture size (mm) | Aperture size (inches) |
|---|---|---|
| ¼ | 6.30 | 0.250 |
| 4 | 4.75 | 0.187 |
| 5 | 4.00 | 0.157 |
| 6 | 3.30 | 0.132 |
| 8 | 2.36 | 0.0937 |
| 10 | 2.00 | 0.0787 |
| 12 | 1.70 | 0.0661 |
| 14 | 1.40 | 0.0555 |

TABLE 3
Results of size determination of pieces of
cereal-like core by sieving analysis

| Piece of cereal-like | Minimum size* | |
|---|---|---|
| core | (mm) | Maximum size (mm) |
| Solnuts Pieces | 2.36 | 4.00 |
| Sunflower seeds | 4.00 | 4.75 |
| Peanut split | 6.30 | — |
| Soybean halves | 4.75 | 6.30 |
| Chocolate chips³ | 4.75 | 6.30 |
| Large oat flakes | 3.30 | 4.75 |
| Sliced cranberries | 4.00 | — |
| Sliced almonds | 6.30 | — |
| Crumbled almonds¹ | 2.36 | — |
| Roasted chopped | 3.30 | 4.75 |
| peanuts¹ | | |
| FXP H0309^{1,2} | 3.30 | — |

*Minimum size is defined based on the sieve aperture size which resulted in the retention of 60% or more of the pieces.
¹Values obtained from manufacturer's technical specifications
²A protein product available from The Solae Company
³Approx. 4000 chocolate chips per pound of chocolate chips

The following measurements were made using a vernier caliper.

| | | |
|---|---|---|
| Peanut split: | length: 1.2 to 1.5 cm | |
| Sliced cranberries: | diameter: 1.5 to 1.7 cm | thickness: 0.3 cm |
| Sliced almonds: | length: 1.8 to 2.0 cm | |

Three types of soy nuggets were used, which represent three extruded forms of soya having different shapes. The sizing above was performed for 2 of these 3 versions; with the size information from the third being obtained from the manufacturer's specifications. Based on these three values, the soya pieces used have an average size of 3.30 mm or more.

Fine coconut pieces: The following sieving values were obtained from the manufacturer's specifications and are set forth in Table 4 below. Further, the pieces were measured to be of about 2 to 3 mm in length and 1 mm wide.

TABLE 4
Fine coconut sieving results (obtained from manufacturer)

% Retained on

| Sieve # | Minimum | Maximum |
|---|---|---|
| 10 | 0 | 1 |
| 14 | 2 | 20 |
| 16 | 10 | 31 |
| 20 | 30 | 65 |
| 30 | 12 | 35 |
| Pan | 1 | 12 |

Proti-oat pieces: Approximately 1.1 cm×0.7 cm (according to manufacturer).

Apple pieces: approximately 6 mm×6 mm×6 mm dice (according to manufacturer).

TABLE 5
Statistical analyses of size of pieces of cereal-like core

| Piece of cereal-like core | Largest dimension (mm) | |
|---|---|---|
| Solnuts pieces | 4.00 | |
| Sunflower seeds | 4.75 | |
| Peanut split | 15.0 | |
| Soy nut halves | 6.30 | |
| Chocolate chips | 6.30 | |
| Large oat flakes | 4.75 | |
| Sliced cranberries | 17.0 | |
| Sliced almonds | 20.0 | |
| Roasted chopped peanuts | 4.75 | |
| FXP H0309 | 3.30 | |
| Fine coconut pieces | 3.00 | |
| Proti-oat pieces | 11.0 | |
| Apple Pieces | 6.00 | |
| Mean | 8.17 ± 5.68 | mm |
| Median | 6.15 | mm |

### Example 10

### Carbohydrate Content

Table 6 shows the carbohydrate content of the products described in Examples 1-7 above. Digestible (net) carbohydrate was calculated as follows:

TABLE 6
Percentage of total carbohydrates and
digestible carbohydrates
$\begin{matrix}Total carbs & - Sugar alcohols \\ & - Glycerin \\ & - 90 \% of polydextrose calculated as dietary fiber \\ & - Dietary fiber \\ & = Digestible carbs ( Net Carbs )\end{matrix}$

| | | % Digestible | % Kcal derived from |
|---|---|---|---|
| | % Total | Carbs | Digestible Carbs |
| Product (Example) | Carbs | (Net Carbs) | (Net Carbs) |
| Applebar (1) | 35.70% | 7.14% | 6.18% |
| chocolate chip bar (2) | 38.41% | 4.53% | 6.18% |
| layered bar (3) | 42.75% | 5.92% | 5.85% |
| granola-type bar A (4) | 36.06% | 8.10% | 7.48% |
| granola-type bar B (5) | 37.97% | 9.51% | 8.56% |
| cookie (6) | 36.33% | 5.14% | 5.08% |
| cereal (7) | 33.74% | 10.32% | 9.21% |

### Example 11

### Amount of Pieces of Cereal-Like Core in Product

Table 7 below sets forth the amount or content of pieces of cereal-like core in the products described in Examples 1-7. Values are expressed by percentage and represent the % by weight of pieces of cereal-like core incorporated into the product.

TABLE 7
Quantity of pieces of cereal-like core
in product (% by weight of product)

| | Quantity of pieces of | Quantity of pieces of |
|---|---|---|
| | cereal-like core in | cereal-like core in total |
| Product (Example) | matrix⁴ (%) | product⁵ (%) |
| apple bar (1) | 56.61 | 36.11 |
| chocolate chip bar (2) | 54.55 | 49.05 |
| Layered bar (3) | 44.25 | 26.30 |
| Granola-type bar A (4) | 55.83 | 45.50 |
| Granola-type bar B (5) | 55.83 | 55.83 |
| cookie (6) | 19.15 | 19.15 |
| cereal (7) | 66.81 | 66.81 |

⁴Matrix refers to the core portion and excludes coating and non-core layer(s) (e.g. of caramel).
⁵Total product refers to the entire product, including any coating and non-core layer(s)

### Example 12

### Analytical Methods

Indicated below are references to standard analytical methods which may be used to measure some of the parameters described herein.

Calories: United States Department of Agriculture, “Composition of Foods”, Agricultural Handbook, No. 8, pp. 159-160 (1982).

Fatty Acids: American Oil Chemists' Society, “Ce 1-62 Fatty Acid Composition by Gas Chromatography”, Official Methods and Recommended Practices of the AOCS, Fifth Ed., American Oil Chemists' Society, Champaign, Ill. (1997).

Cholesterol: Official Methods of Analysis of AOAC INTERNATIONAL (2000) 17th Ed., AOAC INTERNATIONAL, Gaithersburg, Miss., USA, Official Method 994.10.

Dietary Fiber: Official Methods of Analysis of AOAC INTERNATIONAL (2000) 17th Ed., AOAC INTERNATIONAL, Gaithersburg, Md., US, Official Method 985.29.

Sugar Profile: Mason, B. S., and Slaver, H. T., “A Gas Chromatographic Method for the Determination of Sugars in Foods, “Journal of Agricultural and Food Chemistry 19(3):551-554 (1971).; Brobst, K. H., “Gas-Liquid Chromatography of Trimethylsilyl Derivatives, Methods in Carbohydrate Chemistry” 6:3-8, Academic Press, New York, N.Y., (1972).

Protein (N×6.25) Dumas Method: Official Methods of Analysis of AOAC INTERNATIONAL (2000) 17th Ed., AOAC INTERNATIONAL, Gaithersburg, Md., USA, Official Methods 968.06 and 992.15. (i.e. calculated on the basis of the factor of 6.25 times the nitrogen content of the food as determined by the appropriate method of analysis).

Moisture, 100 Degree Vac. Oven: Official Methods of Analysis of AOAC INTERNATIONAL (2000) 17th Ed., AOAC INTERNATIONAL, Gaithersburg, Md., USA, Official Methods 925.09, 926.08.

Ash: Official Methods of Analysis of AG C INTERNATIONAL (2000) 17th Ed., AOAC INTERNATIONAL, Gaithersburg, Md., USA, Official Method 923.03.

ICP Emission Spectrometry: Official Methods of Analysis of AOAC INTERNATIONAL, (2000) 17th ED., AOAC INTERNATIONAL Gaithersburg, Md., US•Official Methods 984..21, 985.01.; Inductively Coupled Plasma-Atomic Emission Spectrometry Analysis of Biological Materials and Soils for Major, Trace, and Ultra-Trace Elements, Applied Spectroscopy, 23:1-29 (1978).

Glycerol: Sweely, Bentley, Makita and Wells, J. A. C. S. 85: 2495-2507 (1963), Pierce, A. E., “Silylation of Organic Compounds”, Pierce Chemical Co., Publisher (1979).

Polydextrose by HPLC: Journal of Chromatography, 299: 28-292. (1984).

### Example 13

### Texture Measurements

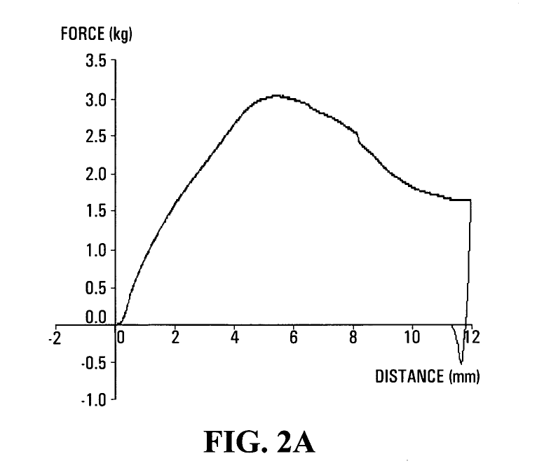

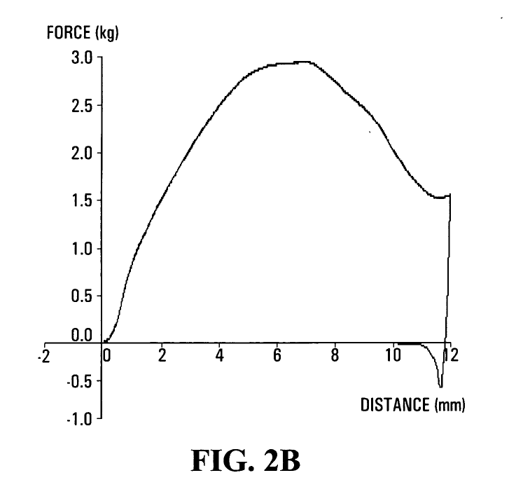

Multiple measurements of the texture of an apple bar (prepared according to Example 1) were determined using a TA.XT Plus texture analyzer machine equipped with a 25 kg load cell (Texture Technologies, Scarsdale, N.Y., USA) using the 45 degree chisel blade test. Briefly, the test entails applying force to the probe to penetrate into the bar a certain distance or depth, with the resulting force applied over the depth of penetration being expressed as a graph. Results for the apple bar are shown in FIG. 1. For purposes of comparison, a corresponding test was performed on a non-cereal bar (Atkins Advantage™ Almond Brownie), with the results shown in FIG. 2. 20 replicate tests were performed for each sample. The machine was calibrated using a 2 kg weight. The set point values used for the relevant parameters for texture measurement are set forth in Table 8.

TABLE 8
TA.XTPlus settings for texture measurement
of apple bar and brownie bar

| Parameter | Set Point Value | Unit |
|---|---|---|
| Pre-Test Speed | 1.00 | mm/sec |
| Test Speed | 2.00 | mm/sec |
| Post-Test Speed | 10.00 | mm/sec |
| Distance | 12.00 | mm |
| Trigger Force | 5.00 | g |

The method for performing the texture measurement is as follows. Analysis is performed under ambient conditions (i.e. room temperature, ambient humidity, etc.):
1. The TA.XT Plus machine is fitted with the TA-42 knife probe with a 45° chisel blade.
2. The force is calibrated using a 2 kg weight.
3. The sample to be analyzed is placed on the base plate.
4. The test is initiated whereby the knife probe travels downward at 1 mm/sec until the device detects 5 g of force, at which point the knife probe advances 12 mm into the sample at a speed of 2 mm/sec. The probe withdraws from the sample at 10 mm/sec.
5. The force (kg) vs. distance of penetration (mm) data is plotted as a graph. The graph represents the average of 5 test replicates for each sample.
   At least 10 replicate samples are performed.

As seen in FIG. 1, the test on the apple bar yielded a profile with a global maximum, i.e. a large, broad peak, with multiple isolated maxima on either side of the global maxima, i.e. the small, jagged spikes or local peaks on the ascending and descending portions of the large peak. Such a profile is likely due to the particulate nature of the cereal-like apple bar, as the probe encounters sharp changes in resistance during penetration as it encounters various pieces of cereal-like core during penetration. In contrast, as seen in FIG. 2, when the same test was run with a non-cereal type bar, in this case the almond brownie bar, the graph exhibits a global maximum (see FIG. 2), however, no surrounding isolated maxima are seen as the force profile is a smooth curve. This is likely due to the smooth, homogeneous, non-particulate dough-type texture of the non-cereal bar, where there is a smooth transition of force upon penetration of the bar, without any sharp changes of resistance.

1. A low carbohydrate ready to eat food product comprising a cereal-like core that forms at least about 15% by weight of said food product.

2. A low carbohydrate ready to eat food product comprising digestible carbohydrate less than or equal to 30% by weight of said food product and at least 15% by volume of identifiable pieces of cereal-like core.

3. A low carbohydrate ready to eat food product comprising a core of agglomerated identifiable cereal-like pieces, wherein said product comprises at least 15% by weight of said agglomerated cereal-like pieces, and wherein said cereal-like pieces have a median size of at least 2 mm.

4. The food product of claim 3, wherein said product comprises at least 20% by weight of said agglomerated cereal-like pieces.

5. The food product of claim 4, wherein said product comprises at least 30% by weight of said agglomerated cereal-like pieces.

6. The food product of claim 5, wherein said product comprises at least 40% by weight of said agglomerated cereal-like pieces.

7. The food product of claim 1, wherein said pieces of cereal-like core are agglomerated.

8. The food product of claim 1, wherein said pieces of cereal-like core are adhered to each other by a binding agent which is substantially free of simple sugars.

9. The food product of claim 1, wherein said product is in a form selected from the group consisting of a bar, a cookie and a cereal comprising clusters of said pieces of cereal-like core.

10. The food product of claim 1, wherein each of said pieces of cereal-like core has a median size of at least 2 mm.

11. The food product of claim 1, wherein said pieces of cereal-like core comprise pieces or nuggets derived from a source selected from the group consisting of grains, cereals, legumes, nuts, seeds, fruit, coconut, caramel and chocolate.

12. The food product of claim 1, wherein said pieces of cereal-like core comprise nuggets comprising less than 40% digestible carbohydrate.

13. The food product of claim 12, wherein said nuggets comprise less than 25% digestible carbohydrate.

14. The food product of claim 13, wherein said nuggets comprise less than 10% digestible carbohydrate.

15. The food product of claim 1, wherein said said pieces of cereal-like core comprise nuggets comprising more than 60% protein.

16. The food product of claim 15, wherein said nuggets comprise more than 75% protein.

17. The food product of claim 16, wherein said nuggets are soya nuggets.

18. The food product of claim 1, wherein said digestible carbohydrate is selected from the group consisting of simple sugars, starch, and any carbohydrate which may be cleaved under physiological conditions to yield simple sugars.

19. The food product of claim 1, wherein said food product comprises at least 20% by weight of said pieces of cereal-like core.

20. The food product of claim 19, wherein said food product comprises at least 30% by weight of said pieces of cereal-like core.

21. The food product of claim 20, wherein said food product comprises at least 40% by weight of said pieces of cereal-like core.

22. The food product of claim 21, wherein said food product comprises at least 50% by weight of said pieces of cereal-like core.

23. The food product of claim 22, wherein said food product comprises at least 60% by weight of said pieces of cereal-like core.

24. The food product of claim 8, wherein said binding agent is a protein-based agent.

25. The food product of claim 24, wherein said binding protein-based agent is hydrolyzed gelatin.

26. The food product of claim 1, wherein said product further comprises indigestible carbohydrate.

27. The food product of claim 26, wherein said indigestible carbohydrate is selected from the group consisting of fiber, gum, cellulose, polydextrose, sugar alcohol, fructo-oligosaccharide, inulin, glycerin and fibersol.

28. The food product of claim 1, wherein said product further comprises an additive selected from the group consisting of a vitamin, a mineral and a flavouring agent.

29. The food product of claim 1, wherein said product is in the form of a solid matrix core and further comprises a coating covering at least a part of said matrix core.

30. The food product of claim 29, wherein said coating is selected from the group consisting of chocolate, carob, peanut-based coating, cream-type coating, yogourt-type coating and a flavoured coating.

31. The food product of claim 29, wherein said coating is substantially free of simple sugar.

32. The food product of claim 29, wherein said product is in the form of a bar, and wherein said coating covers a part of a lower portion of said matrix core.

33. The food product of claim 29, wherein said product is in the form of a bar, and wherein said coating covers a part of an upper portion of said matrix core.

34. The food product of claim 29, wherein said coating covers substantially all of said matrix core.

35. The food product of claim 1, wherein said product is in the form of a solid matrix core and further comprises an edible layer portion situated above or below said matrix core, wherein said layer portion is substantially free of pieces of cereal-like core.

36. A layered food product comprising the food product of claim 1, wherein said food product is in the form of a matrix core, wherein said layered food product comprises at least two of said matrix cores and an edible layer portion situated therebetween, wherein said layer portion occupies at least part of the interface between said matrix cores, and wherein said layer portion is substantially free of pieces of cereal-like core.

37. The food product of claim 35, wherein said layer portion comprises a water-based or fat-based composition selected from the group consisting of caramel, chocolate, peanut, and a flavoured confectionery material.

38. The food product of claim 35, wherein said layer portion is substantially free of simple sugar.

39. The food product of claim 1, wherein said food product has a water activity of 0.2 to 0.4.

40. A low carbohydrate ready to eat food product suitable for a controlled carbohydrate diet, wherein said product comprises less than or equal to 30% by weight of digestible carbohydrate and wherein said food product exhibits a texture profile having an average peak density of at least 1 peak per millimetre penetration depth when analyzed using a TA.XT Plus texture analyzer machine following a 45 degree chisel blade test.

41. A low carbohydrate ready to eat food product suitable for a controlled carbohydrate diet, wherein said product comprises less than or equal to 30% by weight of digestible carbohydrate and wherein said food product exhibits a texture profile having a global maximum at a first depth of penetration and a plurality of isolated local maxima at a respective plurality of second depths of penetration when analyzed using a TA.XT Plus texture analyzer machine following either a 45 degree chisel blade test.

42. The food product of claim 41, wherein said at least one of said second depths of penetration is less than said first depth of penetration.

43. The food product of claim 41, wherein said at least one of said second depths of penetration is greater than said first depth of penetration.

44. The food product of claim 42, wherein said at least one of said second depths of penetration is greater than said first depth of penetration.

45. The food product of claim 41, wherein said plurality of said second depths of penetration are less than said first depth of penetration.

46. The food product of claim 41, wherein said plurality of said second depths of penetration are greater than said first depth of penetration.

47. The food product of claim 45, wherein said plurality of said second depths of penetration are greater than said first depth of penetration.

48. A low carbohydrate ready to eat food product, comprising at most 30% by weight of digestible carbohydrate, said food product having a thickness and exhibiting a texture profile of force versus depth of penetration when analyzed using a TA.XT Plus texture analyzer machine following either a 45 degree chisel blade test, wherein said texture profile is characterized by:
(d) a global maximum force at a first depth of penetration;
(e) a global width equal to the difference between a second depth of penetration and a third depth of penetration, the second depth of penetration being less than the first depth of penetration, the third depth of penetration being greater than the first depth of penetration, the second and third depths of penetration corresponding to respective points on said profile where the force is equal to 50% of said global maximum force, said global width being at least 80% of the thickness of the food product; and
(f) a plurality of local peaks appearing in a density of at least one per millimeter penetration depth, each local peak characterized by a respective fourth depth of penetration at which the force exhibits a local maximum and a respective fifth depth of penetration at which the force exhibits a local minimum, wherein the difference between the respective fourth and fifth depths of penetration is between 1% to 25% of said global width, wherein each local peak is further characterized by a respective local amplitude equal to the difference between the force at the respective fourth depth of penetration and the force at the respective fifth depth of penetration, the respective local amplitude being at least 1% of said global maximum force.

49. The food product of claim 40, wherein said food product comprises a plurality of pieces of cereal-like core.

50. The food product of claim 49, wherein said pieces of cereal-like core are adhered to each other by a binding agent which is substantially free of simple sugars.

51. The food product of claim 49, wherein said product is in a form selected from the group consisting of a bar, a cookie and a cereal comprising clusters of said pieces of cereal-like core.

52. The food product of claim 49, wherein each of said pieces of cereal-like core has a median size of at least 2 mm.

53. The food product of claim 49, wherein said pieces of cereal-like core comprise pieces or nuggets derived from a source selected from the group consisting of grains, cereals, legumes, nuts, seeds, fruit, coconut, caramel and chocolate.

54. The food product of claim 49, wherein said pieces of cereal-like core comprise nuggets comprising less than 40% digestible carbohydrate.

55. The food product of claim 54, wherein said nuggets comprise less than 25% digestible carbohydrate.

56. The food product of claim 55, wherein said nuggets comprise less than 10% digestible carbohydrate.

57. The food product of claim 49, wherein said said pieces of cereal-like core comprise nuggets comprising more than 60% protein.

58. The food product of claim 57, wherein said nuggets comprise more than 75% protein.

59. The food product of claim 58, wherein said nuggets are soya nuggets.

60. The food product of claim 40, wherein said digestible carbohydrate is selected from the group consisting of simple sugars, starch, and any carbohydrate which may be cleaved under physiological conditions to yield simple sugars.

61. The food product of claim 49, wherein said food product comprises at least 20% by weight of said pieces of cereal-like core.

62. The food product of claim 61, wherein said food product comprises at least 30% by weight of said pieces of cereal-like core.

63. The food product of claim 62, wherein said food product comprises at least 40% by weight of said pieces of cereal-like core.

64. The food product of claim 63, wherein said food product comprises at least 50% by weight of said pieces of cereal-like core.

65. The food product of claim 64, wherein said food product comprises at least 60% by weight of said pieces of cereal-like core.

66. The food product of claim 50, wherein said binding agent is a protein-based agent.

67. The food product of claim 66, wherein said binding protein-based agent is hydrolyzed gelatin.

68. The food product of claim 40, wherein said product further comprises indigestible carbohydrate.

69. The food product of claim 68, wherein said indigestible carbohydrate is selected from the group consisting of fiber, gum, cellulose, polydextrose, sugar alcohol, fructo-oligosaccharide, inulin, glycerin and fibersol.

70. The food product of claim 40, wherein said product further comprises an additive selected from the group consisting of a vitamin, a mineral and a flavouring agent.

71. A coated food product comprising the food product of claim 40, wherein said food product is a solid matirix core, and wherein said coated food product further comprises a coating covering at least a part of said matrix core.

72. The food product of claim 71, wherein said coating is selected from the group consisting of chocolate, carob, peanut-based coating, cream-type coating, yogurt-type coating and a flavoured coating.

73. The food product of claim 72, wherein said coating is substantially free of simple sugar.

74. The coated food product of claim 71, wherein said product is in the form of a bar, and wherein said coating covers a part of a lower portion of said matrix core.

75. The coated food product of claim 71, wherein said product is in the form of a bar, and wherein said coating covers a part of an upper portion of said matrix core.

76. The coated food product of claim 71, wherein said coating covers substantially all of said matrix core.

77. The food product of claim 40, wherein said product is in the form of a solid matrix core and further comprises an edible layer portion situated above or below said matrix core, wherein said layer portion is substantially free of cereal like pieces.

78. A layered food product comprising the food product of claim 40, wherein said food product is in the form of a matrix core, wherein said layered food product comprises at least two of said matrix cores and an edible layer portion situated therebetween, wherein said layer portion occupies at least part of the interface between said matrix cores, and wherein said layer portion is substantially free of pieces of cereal-like core.

79. The food product of claim 77, wherein said layer portion comprises a water-based or fat-based composition selected from the group consisting of caramel, chocolate, peanut, and a flavoured confectionery material.

80. The food product of claim 77, wherein said layer portion is substantially free of simple sugar.

81. The food product of claim 40, wherein said food product has a water activity of 0.2 to 0.4.

82. A method for preparing a food product suitable for a controlled carbohydrate diet, said method comprising:
(a) providing ingredients comprising at least 15% by weight of pieces of cereal-like core, wherein said ingredients collectively comprise less than 30% by weight of digestible carbohydrate;
(b) providing a binding agent which is substantially free of simple sugars;
(c) mixing said binding agent with with said ingredients thereby to obtain a moldable mass; and
(d) forming said moldable mass into said food product.

83. The method of claim 82, wherein said moldable mass is formed into a form selected from the group consisting of a bar, a slab, a strip and a cluster.

84. The method of claim 83, further comprising cutting said strip transverse to its long axis thereby to obtain a bar.

85. The method of claim 83, further comprising making a plurality of spaced apart first cuts in said slab thereby to obtain a strip, and cutting said strip at an axis transverse to said first cuts thereby to obtain a bar.

86. The method of claim 83, said method further comprising heating said binding agent prior to said mixing step (c).

87. The method of claim 86, wherein said binding agent is heated to at least 50° C.

88. The method of claim 87, wherein said binding agent is heated to at least 60° C.

89. The method of claim 88, wherein said binding agent is heated to at least 70° C.

90. The method of claim 82, wherein each of said pieces of cereal-like core has a median size of at least 2 mm.

91. The method of claim 82, wherein said pieces of cereal-like core comprise pieces or nuggets derived from a source selected from the group consisting of grains, cereals, legumes, nuts, seeds, fruit, coconut, caramel and chocolate.

92. The method of claim 82, wherein said pieces of cereal-like core comprise nuggets comprising less than 40% digestible carbohydrate.

93. The method of claim 92, wherein said nuggets comprise less than 25% digestible carbohydrate.

94. The method of claim 93, wherein said nuggets comprise less than 10% digestible carbohydrate.

95. The method of claim 82, wherein said pieces of cereal-like core comprise nuggets comprising more than 60% protein.

96. The method of claim 95, wherein said nuggets comprise more than 75% protein.

97. The method of claim 96, wherein said nuggets are soya nuggets.

98. The method of claim 82, wherein said digestible carbohydrate is selected from the group consisting of simple sugars, starch, and any carbohydrate which may be cleaved under physiological conditions to yield simple sugars.

99. The method of claim 82, wherein said food product comprises at least 20% by weight of said pieces of cereal-like core.

100. The method of claim 90, wherein said food product comprises at least 30% by weight of said pieces of cereal-like core.

101. The method of claim 100, wherein said food product comprises at least 40% by weight of said pieces of cereal-like core.

102. The method of claim 101, wherein said food product comprises at least 50% by weight of said pieces of cereal-like core.

103. The method of claim 102, wherein said food product comprises at least 60% by weight of said pieces of cereal-like core.

104. The method of claim 92, wherein said binding agent is a protein-based agent.

105. The method of claim 104, wherein said protein-based binding agent is hydrolyzed gelatin.

106. The method of claim 82, wherein said ingredients further comprise indigestible carbohydrate.

107. The method of claim 106, wherein said indigestible carbohydrate is selected from the group consisting of fiber, gum, cellulose, polydextrose, sugar alcohol, fructo-oligosaccharide, inulin, glycerin and fibersol.

108. The method of claim 82, wherein said ingredients further comprise an additive selected from the group consisting of a vitamin, a mineral and a flavouring agent.

109. The method of claim 82, further comprising applying a particulate additive to a surface of said slab, bar or cluster.

110. The method of claim 109, wherein said particulate additive is selected from the group consisting of nuts, chopped nuts, chocolate chips and chocolate chunks.

111. The method of claim 82, wherein said method further comprises applying a coating to at least a part of said product.

112. The food product of claim 111, wherein said coating is selected from the group consisting of chocolate, carob, peanut-based coating, cream-type coating, yogurt-type coating and a flavored coating.

113. The food product of claim 111, wherein said coating is substantially free of simple sugar.

114. The method of claim 111, wherein said method further comprises applying a coating to substantially all of said food product.

115. The method of claim 83, wherein said method further comprises applying an edible layer portion to said slab, and wherein said layer portion is substantially free of pieces of cereal-like core.

116. The method of claim 83, wherein said method further comprises applying an edible layer portion between a plurality of said slabs, wherein said layer portion occupies at least part of the interface between said slabs thereby to obtained a layered slab, and wherein said layer portion is substantially free of pieces of cereal-like core.

117. The method of claim 115, wherein said layer portion comprises a water-based or fat-based composition selected from the group consisting of caramel, chocolate, peanut, and a flavored confectionery material.

118. The food product of claim 115, wherein said layer portion is substantially free of simple sugar.

119. The method of claim 82, further comprising baking said food product.

120. A food product suitable for a controlled carbohydrate diet produced by the method of claim 82.

121. The food product of claim 120, wherein said product comprises less than or equal to 30% by weight of digestible carbohydrate and wherein said food product exhibits a texture profile having an average peak density of at least 1 peak per millimetre penetration depth when analyzed using a TA.XT Plus texture analyzer machine following either a 45 degree chisel blade test.

122. The food product of claim 120, wherein said product comprises less than or equal to 30% by weight of digestible carbohydrate and wherein said food product exhibits a texture profile having a global maximum at a first depth of penetration and a plurality of isolated local maxima at a respective plurality of second depths of penetration when analyzed using a TA.XT Plus texture analyzer machine following either a 45 degree chisel blade test.

123. The food product of claim 122, wherein said at least one of said second depths of penetration is less than said first depth of penetration.

124. The food product of claim 122, wherein said at least one of said second depths of penetration is greater than said first depth of penetration.

125. The food product of claim 123, wherein said at least one of said second depths of penetration is greater than said first depth of penetration.

126. The food product of claim 122, wherein said plurality of said second depths of penetration are less than said first depth of penetration.

127. The food product of claim 122, wherein said plurality of said second depths of penetration are greater than said first depth of penetration.

128. The food product of claim 126, wherein said plurality of said second depths of penetration are greater than said first depth of penetration.

129. The food product of claim 120, comprising at most 30% by weight of digestible carbohydrate, said food product having a thickness and exhibiting a texture profile of force versus depth of penetration when analyzed using a TA.XT Plus texture analyzer machine following either a 45 degree chisel blade test, wherein said texture profile is characterized by:
(a) a global maximum force at a first depth of penetration;
(b) a global width equal to the difference between a second depth of penetration and a third depth of penetration, the second depth of penetration being less than the first depth of penetration, the third depth of penetration being greater than the first depth of penetration, the second and third depths of penetration corresponding to respective points on said profile where the force is equal to 50% of said global maximum force, said global width being at least 80% of the thickness of the food product; and
(c) a plurality of local peaks appearing in a density of at least one per millimeter penetration depth, each local peak characterized by a respective fourth depth of penetration at which the force exhibits a local maximum and a respective fifth depth of penetration at which the force exhibits a local minimum, wherein the difference between the respective fourth and fifth depths of penetration is between 1% to 25% of said global width, wherein each local peak is further characterized by a respective local amplitude equal to the difference between the force at the respective fourth depth of penetration and the force at the respective fifth depth of penetration, the respective local amplitude being at least 1% of said global maximum force.

130. A method of providing nutritional support to a subject comprising orally administering to said subject the food product of claim 1.

131. The method of claim 130, wherein said method is part of a controlled carbohydrate diet being followed by said subject.

132. The method of claim 130, wherein said subject suffers from a condition associated with defective blood glucose homeostasis.

133. The method of claim 132, wherein said condition is selected from the group consisting of obesity, hyperglycemia, insulin resistance, type I diabetes and type II diabetes.

134. A commercial package comprising the food product of claim 1.

135. The commercial package of claim 134, wherein said package further comprises an indication that the food product is suitable for a low carbohydrate diet.

136. The commercial package of claim 134, wherein said package further comprises an indication that said product is suitable for consumption at breakfast.
